(19) United States
(12) Patent Application Publication
(10) Pub. No.: US 2009/0285133 A1
(43) Pub. Date: Nov. 19, 2009

(54) Method for over-the-air base station management via access terminal relay

(76) Inventors: Sudarshan A. Rao, Bengaluru (IN); Subramanian Vasudevan, Morristown, NJ (US); Jialin Zou, Randolph, NJ (US)

Correspondence Address: Docket Administrator (Room 2F-192);Alcatel Lucent, 600 Mountain Avenue, Murray Hill, NJ, 07974-0636, US

(21) Appl. No.: 12/319,151

(22) Filed: Dec. 31, 2008

Related U.S. Application Data
(63) Continuation-in-part of application No. 12/286,417, filed on Sep. 30, 2008.
(60) Provisional application No. 61/127,903, filed on May 16, 2008.

(51) Int. Cl. H04B 7/14; H04L 5/14

(52) U.S. Cl. 370/279; 370/315

(57) ABSTRACT

An enhanced access terminal (AT) that can serve as a “proxy wireless over-the-air backhaul or relay” is provided, to connect a base station with no backhaul to its neighboring fully functional base station that is connected to the NMS. In a further embodiment, a method is provided for management of the base station with no backhaul via communications links established using the enhanced access terminal.

### RELATED APPLICATION

This application is a continuation in part of U.S. patent application Ser. No. 12/286,417, filed Sep. 30, 2008, published ______ as US Published Application No. ______, the subject matter thereof being fully incorporated herein by reference. This application further claims priority pursuant to 35 U.S.C. Sec 119(e) to U.S. Provisional Application No. 61/127,903, filed May 16, 2008, entitled METHOD FOR OVER-THE-AIR BASE STATION MANAGEMENT VIA ACCESS TERMINAL RELAY, the subject matter thereof being fully incorporated herein by reference.

### FIELD OF THE INVENTION

The invention is related to communication systems and more particularly to systems and methods for routing traffic in wireless communication systems.

### BACKGROUND OF THE INVENTION

A traditional wireless access network consists of a number of base stations (access points) connected to a centralized controller (radio network controller/base station controller) using wired links (copper, co-axial cable, fiber). The radio network controllers are connected back to circuit-switches or packet-data routers which in turn connect to the wired telecommunications infrastructure (the core network). This traditional, hierarchical network is shown in FIG. 1.

In typical base station deployments in current networks, a wired connection is usually required from each base station to the controller and then onwards to the core network. In the vast majority of cases, these wired links are T1, E1, Ethernet or fiber links. In some rare cases, specialized dedicated line-of-sight microwave links are employed that use separate spectrum. Implementation of such dedicated backhaul connections is usually expensive. There may also be pairs of base stations in an existing network for which a dedicated backhaul connection can not be reliably or economically implemented.

Further, the actual numbers of infrastructure nodes (base stations or access points) is likely to increase by a few orders of magnitude. Typically, each of the large service provider networks today consist of in excess of 50,000 cells sites at which base stations are located. It is not unrealistic to expect such numbers to grow by a factor of 100 to about 5 million. Such large number of base stations will be needed to ensure truly ubiquitous data coverage. It is also likely that many of these new access points cannot be easily supported with a wired backhaul to the core network.

Two particular backhaul-related problems typically need to be addressed in respect to infrastructure management for cellular wireless networks:
(1) When a Base station (BTS) loses backhaul connectivity to the rest of the controlling network due to fault conditions, the network management system (NMS) needs a mechanism to establish remote connection with the faulty BTS to isolate the source of the fault and initiate recovery process; and
(2) In the present art, RF configuration and optimization can be performed only when the BTS is integrated into the network via a backhaul, which may be missing or out of service.

In the case of fault isolation and trouble-shooting of base-stations, techniques in current cellular networks rely on the ability of the network operators to correlate information from many diverse sources. Quite often, the back-haul connection is leased from third-party service providers. Many times, when a lack of service is detected from a base-station, the root-cause cannot be clearly isolated to the wired network or the base-station RF chain for several hours, if not longer. There is no other mechanism available today to log-in to affected base-stations remotely when a backhaul may be malfunctioning. A site visit is required by a technician to confirm or rule out a mal-functioning base-station. This very expensive site visit could be avoided if another mechanism were made available to diagnose base-stations remotely.

For the second case, RF configuration optimization can be performed only when the BTS is integrated into the network via a backhaul. The only other way is to manually plug in a laptop to the BTS on-site with all relevant software and hardware to configure the BTS.

### SUMMARY OF INVENTION

A method for overcoming the above-described problems and improving BTS fault and configuration management is presented herein. The basic idea is to use an enhanced access terminal (AT) that can serve as a “proxy wireless over-the-air backhaul or relay” (henceforth referred to as an AT Relay or ATR in the text and figures) to connect a BTS with no backhaul to its neighboring fully functional BTS that is connected to the NMS. The invention provides a new paradigm that includes over-the-air fault and configuration management of a BTS and adds new protocols and messaging to the air interface specifications, fault and configuration management applications software to enable these functions.

AT relay function can be used to remotely login and communicate to base-stations (whose backhaul may be unavailable or out-of-service). Once an over-the-air communication path is established, fault and configuration management procedures may be initiated. This can be initiated by a technician sitting remotely at the network management system center (NMS) or automatically by issuing commands that are routed through neighboring base-stations and an AT Relay based backhaul that is in the overlapping coverage area of faulty (broken backhaul) base-station and a fully functioning base-station.

The BTS without a backhaul also has the option of broadcasting a request for fault and configuration management services. AT relays in the vicinity that are capable of establishing communications with neighboring base-stations and act as a relay may respond to this request by the BTS. Based on specialized protocols and software resident in the BTSs, AT relays and network management systems, over-the-air fault and configuration management can proceed.

### BRIEF DESCRIPTION OF THE FIGURES

FIG. 1 provides a schematic illustration of an hierarchical wireless network

FIG. 2 schematically illustrates connectivity among plural base stations and a network management system (NMS).

FIG. 3 illustrates a scenario for the base station/NMS arrangement of FIG. 2 in which one of the base stations has lost the capability to communicate directly with the NMS over the wired backhaul, along with a rerouting of that traffic via an AT Relay, according to the method of the invention.

FIG. 4 the flow of fault management protocol messages in a base station via the Transmit and Receive RF chain

FIG. 5 schematically depicts fault management agent software as part of the application software resident in base stations, ATRs, radio network controllers and network management systems.

FIG. 6 shows, at a high level, the call flows implemented during the fault management process for the case of an interrupted or missing backhaul leg between a base station and NMS which has been reestablished via an ATR.

FIG. 7 shows call flows for an NMS initiation of the fault management process.

FIG. 8 provides a schematic depiction of over the air configuration management message flow between a first base station and a second base station in communication with RNC and NMS, via an AT Relay.

FIG. 9 depicts the flow of configuration management protocol messages in the base station via the transmit and receive RF chain.

FIG. 10 illustrates call flow for a base station lacking backhaul initiating over the air configuration management requests.

FIG. 11 illustrates call flow for the case of NMS initiating over the air configuration management request to the first base station (lacking backhaul) via the second base station.

### DETAILED DESCRIPTION OF THE INVENTION

In the parent application (U.S. Ser. No. 12/286,417) for this continuation in part application, the inventors disclosed a new wireless relay function implemented in a wireless mobile unit, identified as a wireless Access Terminal Router (ATR). The present continuation-in-part application is directed to an application of that ATR relay function in the management of fixed elements in a wireless system.

A method is disclosed herein for over-the-air provisioning of a wireless base station using a connection from another base station via an access terminal adapted to relay signals between base stations. The inventive method is particularly suited to address the following over-the-air provisioning cases:
(a) over-the-air (OTA) network configuration of base station (BTS) operational parameters when (i) the BTS does not have a wired backhaul available or (ii) even when backhaul connectivity is available, in some cases, it may be more efficient to coordinate inter-BTS RF performance optimization and configuration parameters over the air.
(b) over-the-air (OTA) fault management of base station when the BTS backhaul is faulty and has lost connectivity to the base-station controller or radio network controller and network management system (NMS).

Each of these base-station provisioning scenarios is addressed by the method of the invention by establishing a wireless communication link between the BTS with fault, or the BTS that needs its configuration parameters updated, and one or more of its immediate neighboring BTSs that have a backhaul connection to the rest of the wired network and network management systems, via specialized wireless access terminals acting as bidirectional relays. Configuration and fault management messages are relayed by these specialized wireless access terminals over the air between adjacent BTSs.

An access terminal (AT) with specialized routing capabilities is described in the parent application hereof (U.S. Ser. No. 12/286,417). As described in the referenced '417 parent application, a specialized AT based relay (henceforth called ATR) can serve as a “wireless proxy backhaul or relay” to establish communication over-the-air between neighboring base-stations. Leveraging ATRs by using the relay and backhaul functions to participate in fault and configuration management functions provides a further powerful application of the ATR invention.

This methodology of leveraging ATRs for fault management is applicable to any air-interface technology that can support the mechanisms presented in the referenced '417 parent application.

### (A) Over-the-Air Fault Management (OTA-FM)

In the case of fault isolation and trouble-shooting of base-stations, techniques in current cellular networks rely on the ability of the network operators to correlate information from many diverse sources. Quite often, the back-haul to the base-station is leased from third-party service providers.

Many times, when a lack of service is detected from a base-station, the root-cause cannot be clearly isolated to the wired network or the base-station RF chain for several hours, if not longer. The fault isolation can only be accomplished by sending a technician out to the cell site, which may often take significant time, effort and expense. There is no other mechanism available today to login to affected base-stations remotely when a backhaul may be malfunctioning and the network management system (NMS) has direct communication with a base station.

According to the method of the invention, a BTS, on detecting the loss of backhaul communication with the NMS, is capable of (a) transmitting alarms over the air seeking cooperation from neighboring BTSs, via ATRs, to assist in fault isolation and recovery procedures and (b) respond to specialized fault management commands being issued over the air.

NMS has the capability, on detecting the loss of connectivity to a BTS and the inability to control and manage the BTS, to (a) establish connection over-the-air with the faulty BTS via its neighboring BTSs and one or more ATRs (b) send remote command requests for diagnostic tests and fault isolation and recovery procedures and (c) obtain results and process results for further action.

BTS, NMS and ATRs cooperate and coordinate the various fault management functions outlined above, via newly specified protocols and message exchanges as described more fully below.

Availability, reliability, and time-to-repair faults are key concerns for service providers and network operators. Fault management is the set of functions that detect, isolate, and correct malfunctions in a communications network. This includes examining error logs, acting on error detection notifications, carrying out sequences of diagnostics tests, localizing faults, correcting faults, and reporting the results of corrective actions.

The more rapid and reliable restoration of service is, the less loss of revenue a fault will cause. Automatic software reconfiguration may be attempted as the first step in the restoration of service. Reconfiguration saves considerable revenue for the Service Provider in the case of many faults by restoring partial or complete service before a technician can get to a base-station with a fault.

In the case of fault isolation and trouble-shooting of base-stations, techniques in current cellular networks rely on the ability of the network operators to correlate information from many diverse sources. Quite often, the back-haul is leased from third-party service providers. Many times, when a lack of service is detected from a base-station, the root-cause cannot be clearly isolated to the wired network or the base-station RF chain for several hours, if not longer. There is no other mechanism available today to login to affected base-stations remotely when a backhaul may be malfunctioning. A site visit is required by a technician to confirm or rule out a malfunctioning base-station. This very expensive site visit could be avoided if another mechanism were made available to diagnose base-stations remotely.

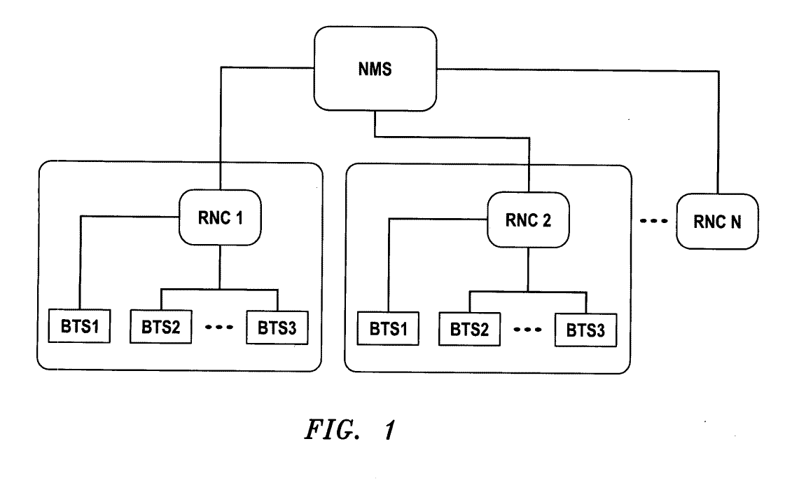

FIG. 1 shows a hierarchical cellular network. The BTSs are at the lowest level of the network hierarchy owned by network operators. Generally, a cluster of BTSs are controlled by a radio network controller (RNC) or sometimes also referred to as a base-station controller (BSC). The RNC term will be used in the rest of the document. Several RNC clusters are managed by a single network management system (NMS). The NMS is the interface for all OAM&P functions. This includes fault, configuration, administration, performance and security (often referred to by the acronym FCAPS).

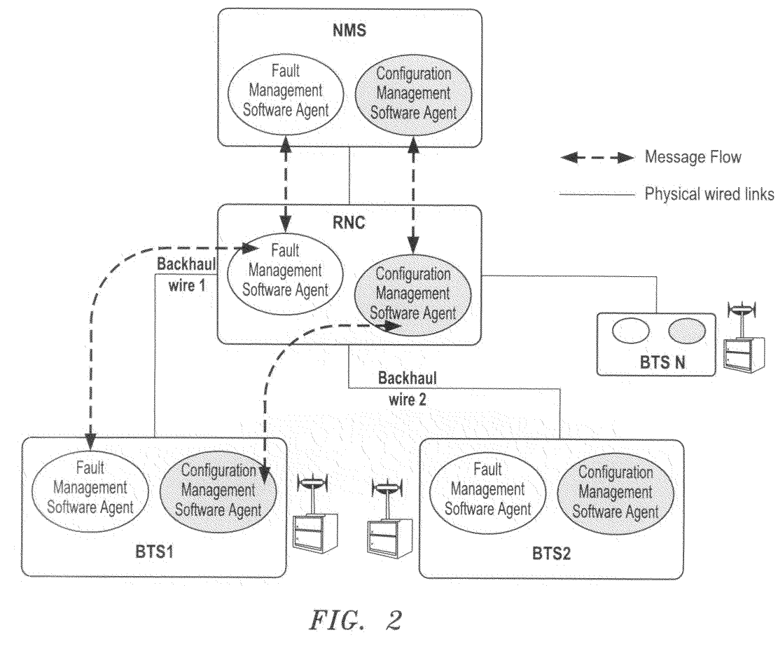

FIG. 2 illustrates two base stations, BTS1 and BTS2, connected to a network management system (NMS). Under normal conditions when the BTSs have backhaul connectivity, the NMS communicates directly to the BTS software via established network management protocols.

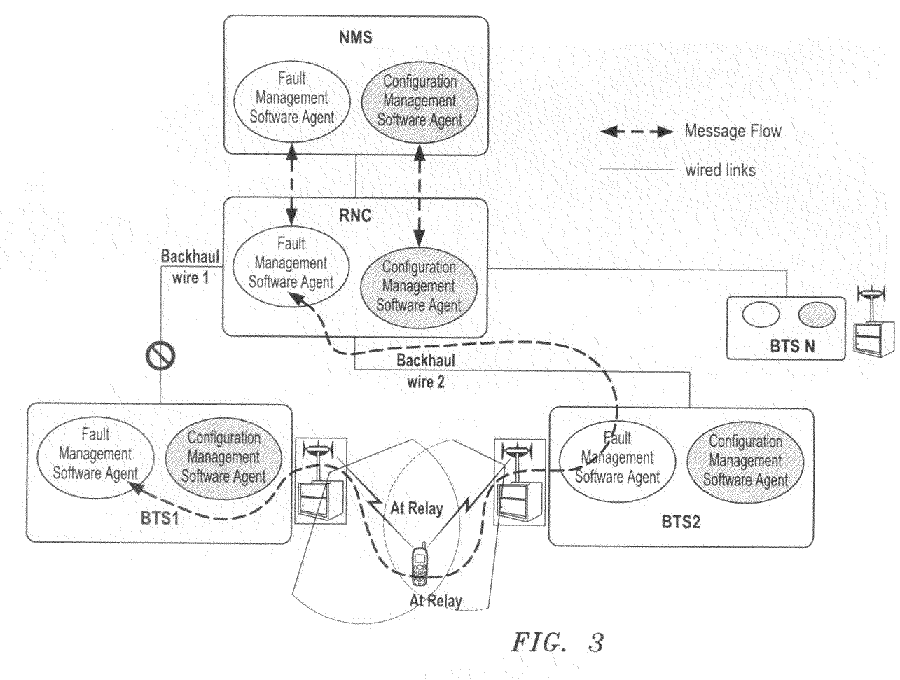

FIG. 3 illustrates a case where BTS1 and NMS have lost the capability to communicate directly over the wired backhaul. This may be a result of backhaul being out-of-service due to physical disconnection, severe degradation in the links causing excessive errors, glitches in network interconnection and interface software or errors in configuration of network parameters.

As a result of detection of loss of backhaul 1 connecting BTS1 and NMS, a fault management process is triggered. Two possible scenarios exist—BTS1 autonomously initiates the fault isolation and recovery process or the NMS initiates the process. In either case, it is necessary to establish a communication path between BTS1 and NMS.

As also shown in FIG. 3, a communications path is implemented between BTS1 and NMS via an AT Relay that serves as a backhaul bridge or route to a neighboring BTS2 and on to the NMS via the wired backhaul 2 and RNC. Such an application of an AT Relay as a backhaul mechanism is described particularly in the parent '417 application.

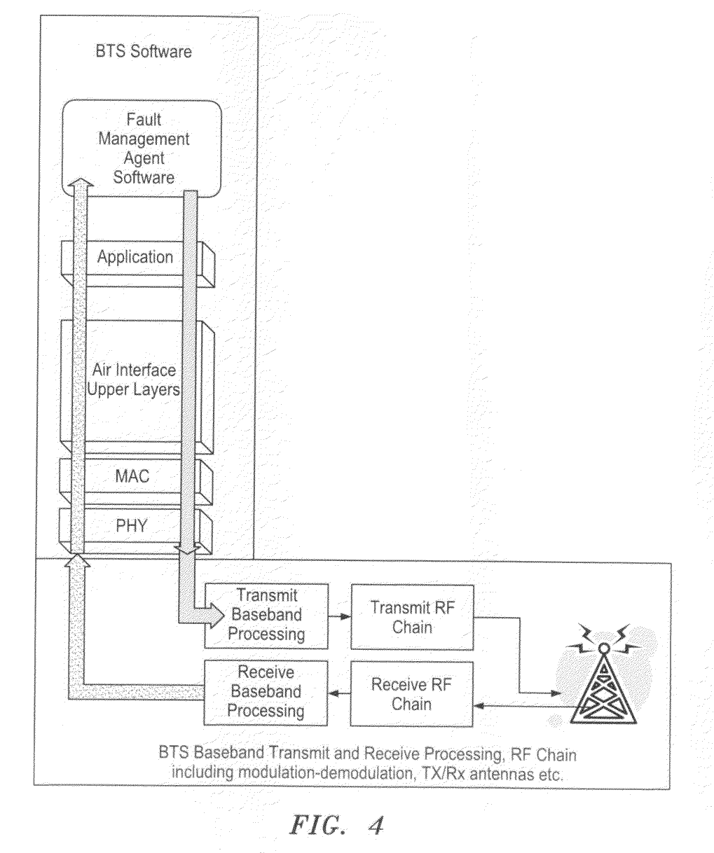

Each BTS has fault management software agents that perform certain predefined tasks based on messages received via its RF and baseband signal processing components and protocol stack. Similarly, the BTS transmits its fault management messages and results via its transmit RF and baseband chain. This is depicted in FIG. 4.

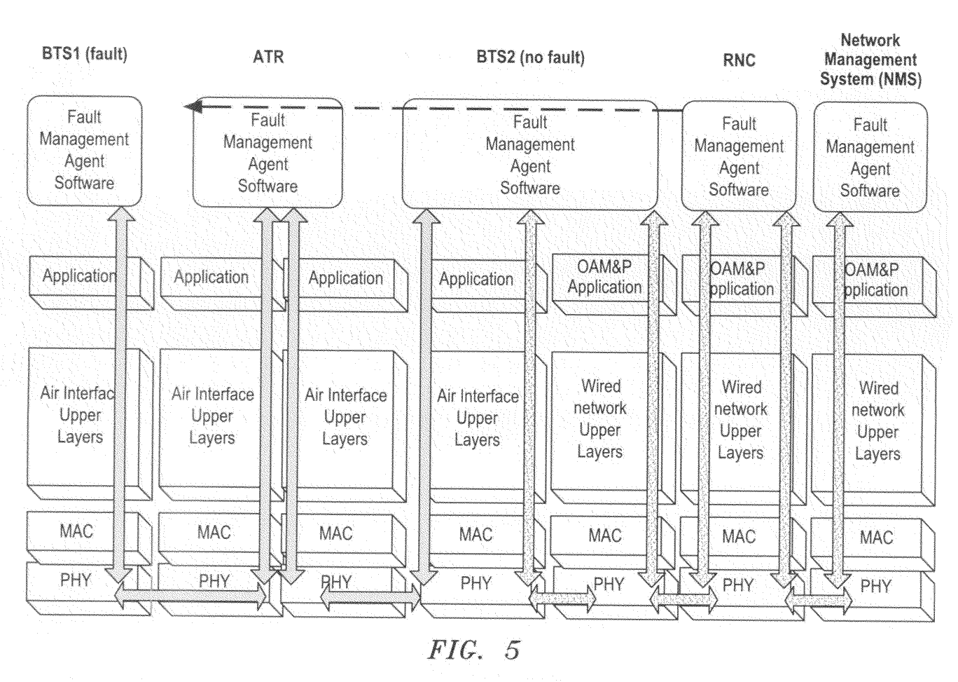

Generally, a suite of distributed fault detection, isolation and recovery software routines exist in agents residing in base-stations. RNCs and network management systems (NMS) as a part of the overall Operations, Administration, Management and Performance (OAM&P) application software. These software agents participate in the fault management process, generally coordinated by the NMS. The fault management application software includes routines for running hardware diagnostics, several layers of recovery and restoration routines that may include partial or full system reboot, link loopback tests to verify connectivity between various network elements, etc. This is generically shown in FIG. 5 as fault management agent software as part of the application software resident in BTSs, ATRs, RNC and NMS. The dashed line arrow connecting the top layer fault management agent software illustrates the information flow and message exchange during the process of fault isolation and recovery. The physical path taken by the messages and information traverses the vertical arrows through the physical layer between the BTSs and AT over the air. BTS2 is connected to RNC and NMS via a wired backhaul and can exchange messages via the wired physical medium, which may be T1/E1 links, Fiber etc.

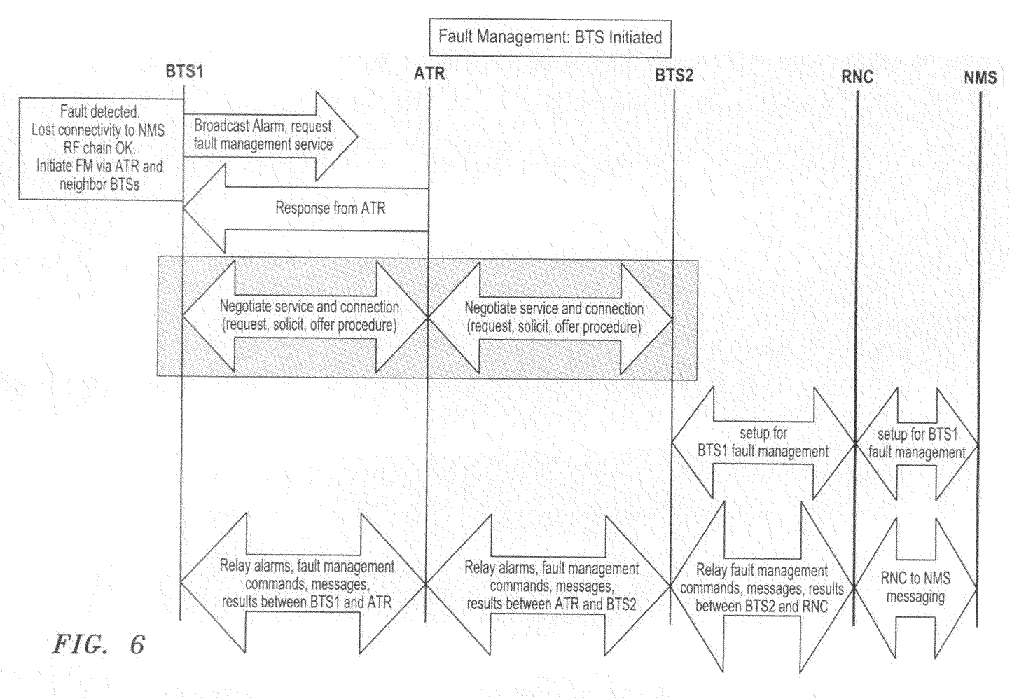

FIG. 6 shows BTS1, on detecting loss of backhaul 1 to RNC and NMS, initiating fault recovery process. The call flow is intended to show, at a high level, the logical steps during the fault management process. BTS1 broadcasts the loss of backhaul and solicits help from ATs that can act as a backhaul between itself, BTS1, and its neighboring BTSs, illustratively, BTS2. Note that BTS1 may have several neighbors and it is entirely possible that different ATRs may be able to provide backhaul connectivity to different BTSs. FIG. 6 is a simplified diagram that only considers BTS2 for easier exposition and clarity. According to the illustrated case, ATRs in the coverage area of BTS1 and BTS2 offer to help. The next set of messages in the boxed area is intended to point to descriptions provided in the parent '417 application. After the establishment of backhaul through the ATR, fault management messages are exchanged between BTS1 software agents and BTS 2, RNC and NMS software agents, via the ATR. These messages include specific requests and commands from NMS, RNC and BTS2 to BTS1 and responses and results from BTS1.

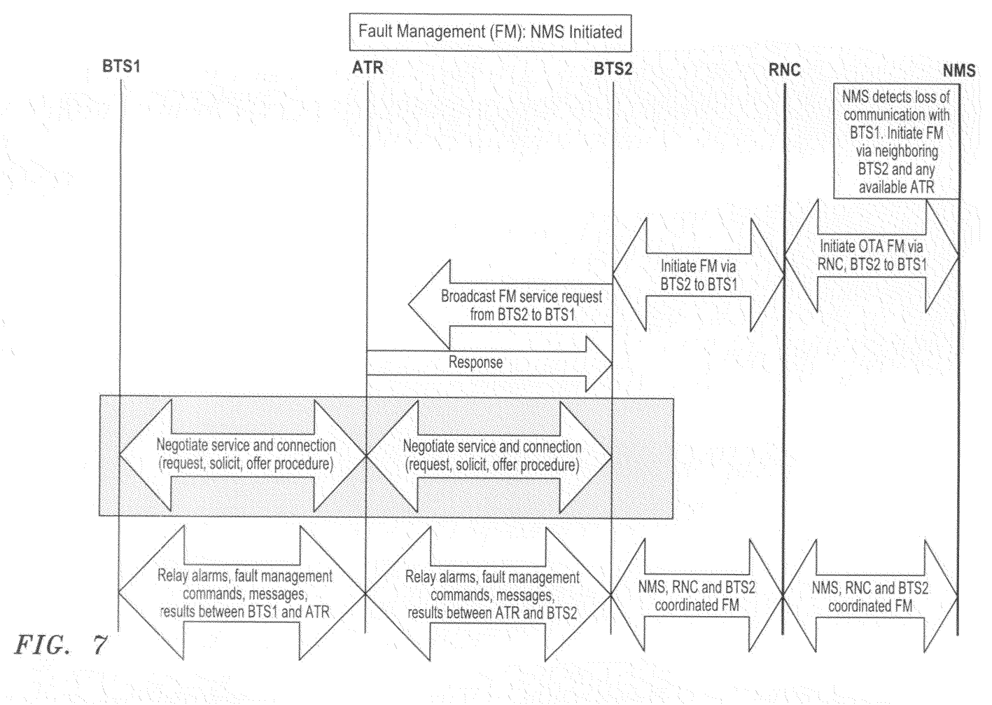

FIG. 7 shows NMS initiating the fault management process when it detects loss of communication with BTS1. Since NMS is aware of the overall network configuration, it (NMS) enlists the nearest neighbors to BTS1 to assist in diagnosis and management of BTS1. FIG. 7 shows only BTS2 for illustrative purposes, but other BTSs may also be involved, simultaneously or in sequence. In FIG. 7, BTS2 solicits help from ATRs that can serve as a backhaul between BTS2 and BTS1. Once the backhaul is established, fault management messages are exchanged between NMS, RNC, BTS2 and BTS1, which are linked over the air by an ATR.

### (B) Over-the-Air Network Configuration Management (OTA-NCM)

i. Femto and Pico Cell Management

As millions of pico and femto cells get deployed, configuration and optimization of pico and femto cells will be a major burden of service providers and end users alike. The various combinations of RF interactions, i.e. macro-to-pico, macro-femto, femto-femto, pico-femto etc. need to be managed efficiently with minimal technician and end-user effort. Minimizing interference to macro cells and optimizing femto/pico coverage can be time-consuming, especially if they happen to be on the same carrier. A mechanism that allows for simple macro-cell base-station to co-ordinate the configuration and optimization with the femto/pico cell would be highly beneficial.

An ATR, as described in the parent '417 application, due to its ability to provide connectivity between macro BTS and femto or pico cells allows for easier coordination. An ATR is used as a link between the macro-BTS, in coordination with the NMS, to provide signaling and control for auto-configuring and optimizing the pico/femto cells.

ii. Macro Cellular RF Optimization

A frequently encountered field issue is the absence of a backhaul during initial base-station installation. In that circumstance, optimization of RF assets requires a subsequent site-visit after a backhaul becomes available, adding significantly to operational expense. ATRs may be productively applied under these circumstances for RF optimization when new BTSs are being added to the network.

The coverage of new BTSs or new carriers has to be adjusted in relation to its neighbors. By having the ATR communicate simultaneously with two neighboring base-stations, they can cooperate, coordinate and fine tune their RF coverage, handoff and neighbor list parameters easily in real-time.

An ATR can serve as an over the air bridge or conduit or link between two BTSs to exchange all relevant configuration parameters that are useful for optimizing the RF performance of the network as described in more detail below.

A BTS is capable of (a) transmitting specialized configuration management service requests over the air, via its baseband and RF transmit chain, to its neighboring BTSs, via ATRs, to assist in RF optimization procedures and (b) responding over-the-air to specialized configuration management commands being received over the air through its receive RF and baseband chain and (c) coordinating with NMS when the BTS is connected via a backhaul to the rest of the network.

NMS has the capability to initiate over-the-air configuration management functions under the following conditions: (i) autonomously (ii) upon manual commands issued by a technician or (iii) on receiving the special over-the-air configuration management requests routed to it. During the process, NMS can (a) establish communication with a BTS, via specialized protocols, over-the-air via its neighboring BTSs and ATRs (b) exchange messages and (c) obtain results and process results for further action.

BTS, NMS and ATRs cooperate and coordinate the various configuration and RF optimization management functions outlined above, via newly specified protocols and message exchanges.

Consider the following more detailed description of the Network Configuration Management methodology. FIG. 2 illustrates two base stations, BTS1 and BTS2, connected to an RNC and network management system (NMS). Under normal conditions the configuration management service agents, which are part of the NMS, communicates with the BTS configuration management agents through the RNC via established network management protocols.

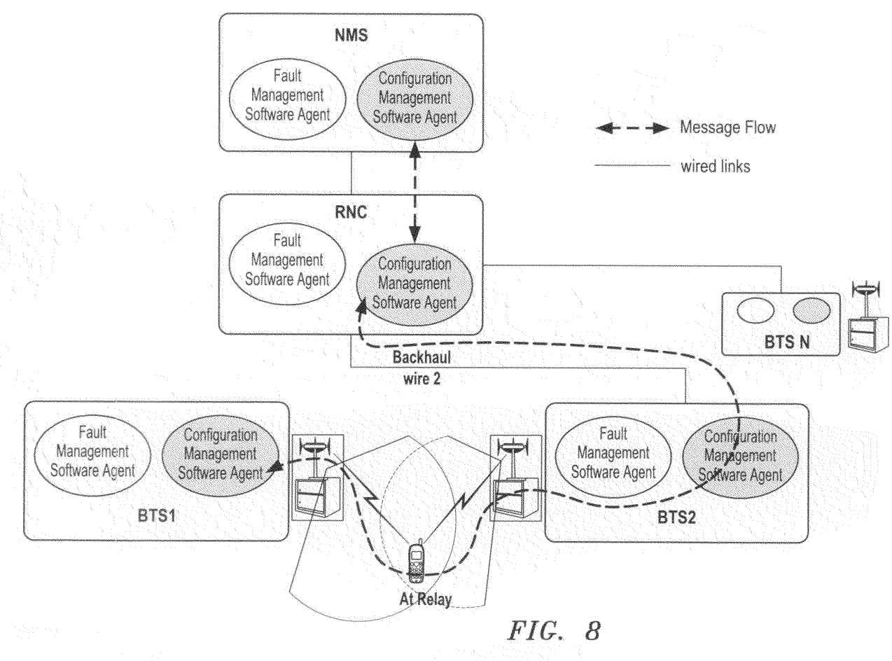

FIG. 8 illustrates configuration management message flow between BTS1 and NMA via RNC, BTS2 and ATR. This connection and flow includes new enhancements to existing air-interface protocols, as well as new mechanisms in the configuration management agents in the BTS, NMS and RNC.

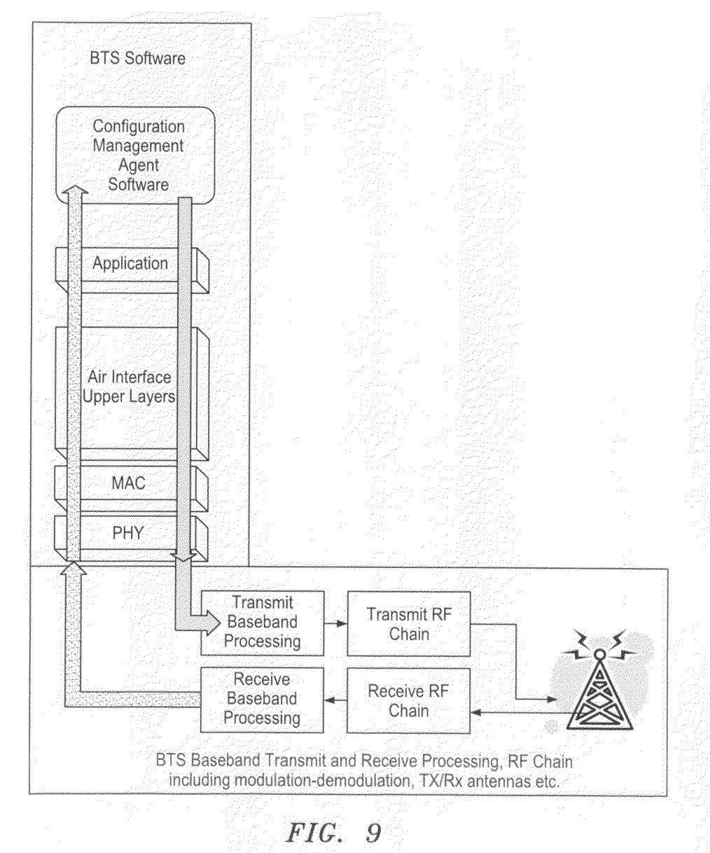

FIG. 9 shows configuration management message flowing over-the air to and from the agent resident in the BTS via the receive and transmit chains of the BTS. These flows include new protocol additions for encapsulating configuration management messages and sent over the air interface protocols.

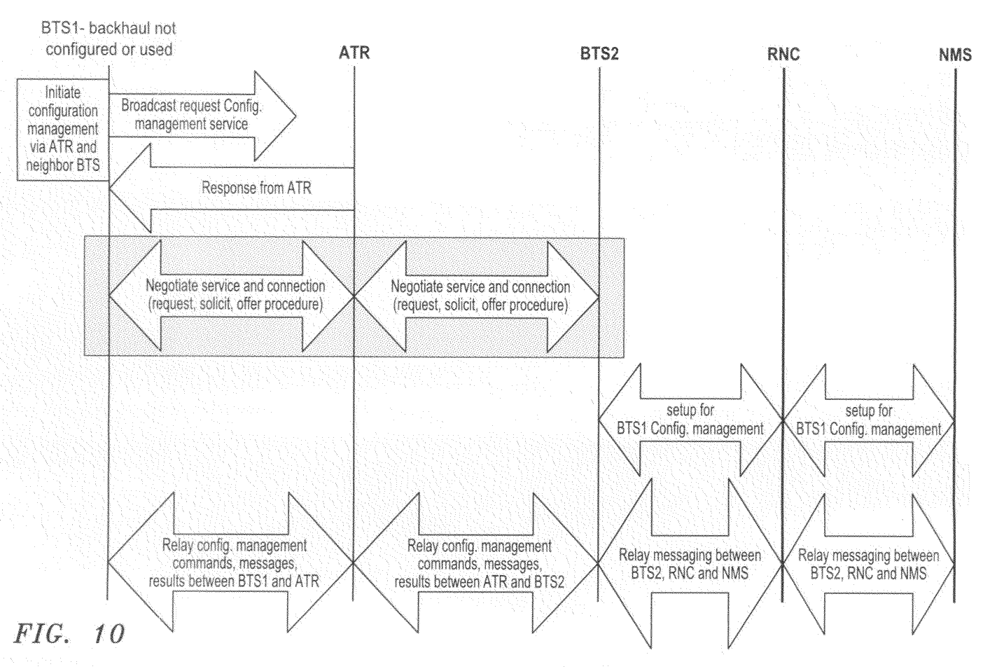

FIG. 10 shows high level configuration management call flows that were initiated by BTS1. BTS1 broadcasts a request for configuration management service. ATRs in the vicinity that can provide this service respond. Negotiations between BTS1 and ATR and BTS2 and ATR take place to ensure availability of adequate air-interface resources (depicted in box). The more detailed negotiation is described fully in the parent '417 application. Once the BTS1 to BTS2 “proxy wireless backhaul” is set up, BTS2 sets up links to the RNC and the NMS. End-to-end message flow between BTS1 to BTS to RNC to NMS takes place until the configuration management process is completed or terminated.

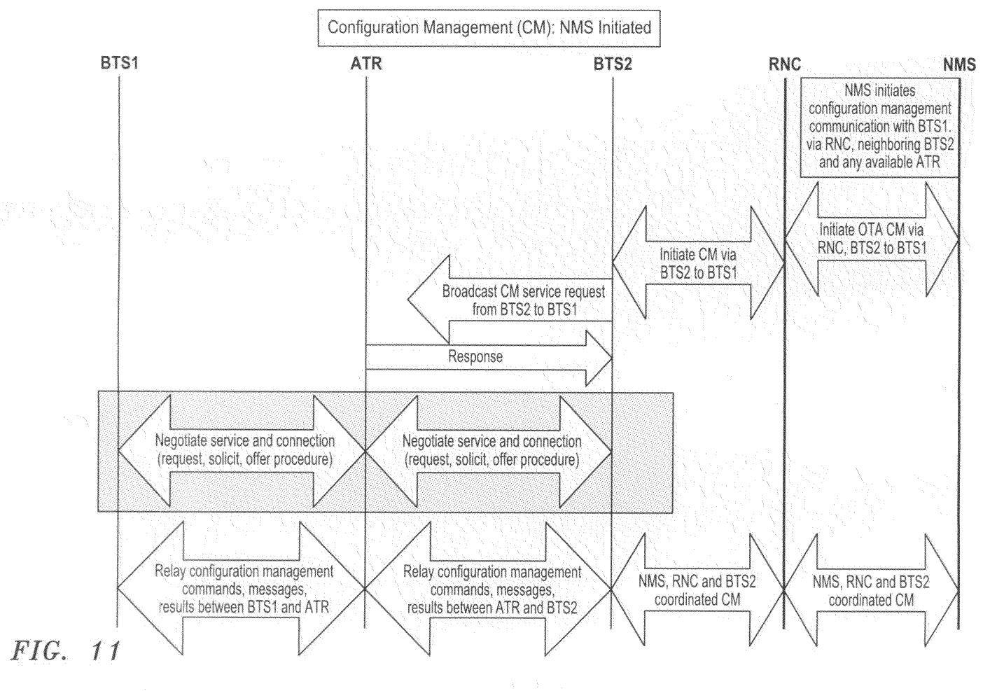

FIG. 11 shows call flows where NMS initiates the configuration management process. NMS initiates a request to the RNC and nearest BTS (e.g. BTS2) to BTS1. BTS2 broadcasts a request for configuration management service. ATRs that can offer their service respond to this broadcast. Once a “proxy wireless backhaul” is setup, configuration management proceeds via message exchanges between NMS, RNC, BTS2 and BTS1.

Herein, the inventors have disclosed a method and system for applying an access terminal relay to provide an over-the-air transmission path as a replacement for an out of service or missing backhaul connection. Numerous modifications and alternative embodiments of the invention will be apparent to those skilled in the art in view of the foregoing description.

Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention, and that the exclusive use of all modifications which come within the scope of the appended claims is reserved.

1. In a wireless communication system including an access terminal and at least two base stations, a method for providing a communications path between a first base station and a second base station via the access terminal comprising the steps of:
providing the access terminal with a transmission/reception capability complementary with that of both the first and second base stations; and
causing the access terminal to receive a message transmitted by the first base station and in turn retransmit the message to the second base station.

2. The method of claim 1 wherein at least one of the first and second base stations lacks a backhaul connection to another network node.

3. The method of claim 2, wherein network configuration management of the at least one base stations is carried out over-the-air via the communications path between base stations established via the access terminal.

4. The method of claim 2, wherein fault management of the at least one base stations is carried out over-the-air via the communications path between base stations established via the access terminal.

5. The method of claim 2 wherein the at least one base station lacking a backhaul connection is a Femtocell base station.

6. The method of claim 1 wherein the access terminal is enabled to operate in separate modes, a first mode being said receipt of a message from a first base station and retransmittal of the message to the second base station (hereafter “backhaul mode”), and a second mode characterized by receiving a message transmitted by at least one of the base stations and in turn transmitting a response message to the at least one base station (hereafter “access mode”).

7. The method of claim 6 wherein air-interface resources are dynamically shared between the access and backhaul modes using a single set of device protocols.

8. An access terminal established to concurrently transmit via a wireless medium two or more independent streams of data to two or more base stations, each data stream being transmitted to a different base station.

9. The access terminal of claim 8 further established to concurrently receive two or more independent data streams from base stations to which the access terminal is transmitting data.

10. The access terminal of claim 9 wherein the access terminal transmits data received by it on a downlink from one base station via an uplink to another base station.

11. The access terminal of claim 10 further including a selector in the access terminal operative to determine the uplink on which data received on a particular downlink is to be transmitted.

12. The access terminal of claim 10 wherein the data received on a particular downlink is retransmitted on more than one uplink

13. The access terminal of claim 8 wherein the access terminal is owned and operated by a service provider of a wireless communication system including at least one of the first and second base stations.

14. The access terminal of claim 10 wherein the uplink and downlink are Frequency Division Duplexed.

15. The access terminal of claim 9 further including a determination by the access terminal of supportable data rates on each uplink-downlink channel pair based on control signaling transmitted between itself and ones of the first and second base stations.

16. The access terminal of claim 15 wherein the access terminal reports said supportable data rates in response to a solicitation for operation in the backhaul mode by the access terminal.

17. The access terminal of claim 10 established at a given location to provide wireless system coverage extension.

18. The access terminal of claim 10 wherein at least one of the base stations is a Femtocell and the access terminal provides signaling and control for autoconfiguring the Femtocell.

19. The access terminal of claim 9 wherein the access terminal is established to monitor and report measurements and alarms for at least one of the first and second base stations.

20. The access terminal of claim 8 wherein the access terminal is owned and operated by individual subscribers and offers to cooperate with the base-stations and network owned by a service provider.

21. The access terminal of claim 10 wherein the uplink and downlink are Time Division Duplexed
